(19) United States
(12) Patent Application Publication
(10) Pub. No.: US 2016/0036650 A1
(43) Pub. Date: Feb. 4, 2016

(54) MICROCONTROLLER AT A CARTRIDGE OF A CHASSIS

(71) Applicant: HEWLETT-PACKARD DEVELOPMENT COMPANY, L.P., Houston, TX (US)

(72) Inventors: Andrew Brown, Houston, TX (US); Peter Hansen, Cypress, TX (US); Leopoldo Alaniz, Spring, TX (US); Chanh V Hua, Houston, TX (US)

(21) Appl. No.: 14/782,317

(22) PCT Filed: Apr. 3, 2013
(86) PCT No.: PCT/US2013/035172

§ 371 Date: Oct. 2, 2015

(51) Int. Cl. H04L 12/24

(52) U.S. Cl. CPC H04L 41/24; H04L 41/0803

(57) ABSTRACT

A method for monitoring computing resources of a cartridge is described herein. The method may include receiving, via the microcontroller, data associated with the computing components of the cartridge. The method may include providing, via the microcontroller, the data based on the monitoring to a management controller that is remote from the cartridge. The method may include analyzing, via the management controller, the data received. The method may include communicating, via the management controller, operational signals based on the analysis to the microcontroller in response to data received.

### BACKGROUND

Networked computing systems generally include host computing devices configured to provide resources such as storage, applications, databases, and the like. The host computing device may be a server such as a database server, file server, mail server, print server, web server, or some other type of server configured to provide services to client devices within a network.

A blade server is a server computer having a modular design optimized to minimize the use of physical space. Whereas a standard rack mount server can function with a power cord and network cable, a blade server has many components removed for the purpose of saving space, minimizing power consumption and other considerations, while still having all the functional components to be considered a computer. A multi-slot chassis can hold multiple blade server cartridges and provide shared resources such as power, cooling, networking, various interconnects, and management. In some complex scalable server environments, full centralized management may be difficult. Some blade servers include a full management processor at each server configured to manage the server. However, including a full management processor at each server increases space and cost per server.

### BRIEF DESCRIPTION OF THE DRAWINGS

Certain examples are described in the following detailed description and in reference to the drawings, in which:

FIG. 1 is a block diagram illustrating a cartridge including computing resources and a microcontroller;

FIG. 2 is a block diagram illustrating the microcontroller in communication with the computing components and the management controller

FIG. 3 is a block diagram illustrating cartridges of a rack having a microcontroller coupled to the management controller; and

FIG. 4 is a block diagram of a method of monitoring components of a cartridge.

### DETAILED DESCRIPTION OF SPECIFIC EMBODIMENTS

The present techniques relate to a microcontroller at each cartridge in a multi-slot cartridge environment. The microcontroller may serve as a proxy to a management controller at each server by monitoring the computing components of the cartridge and providing monitoring data to a remote management controller to process the data and provide responses to the data.

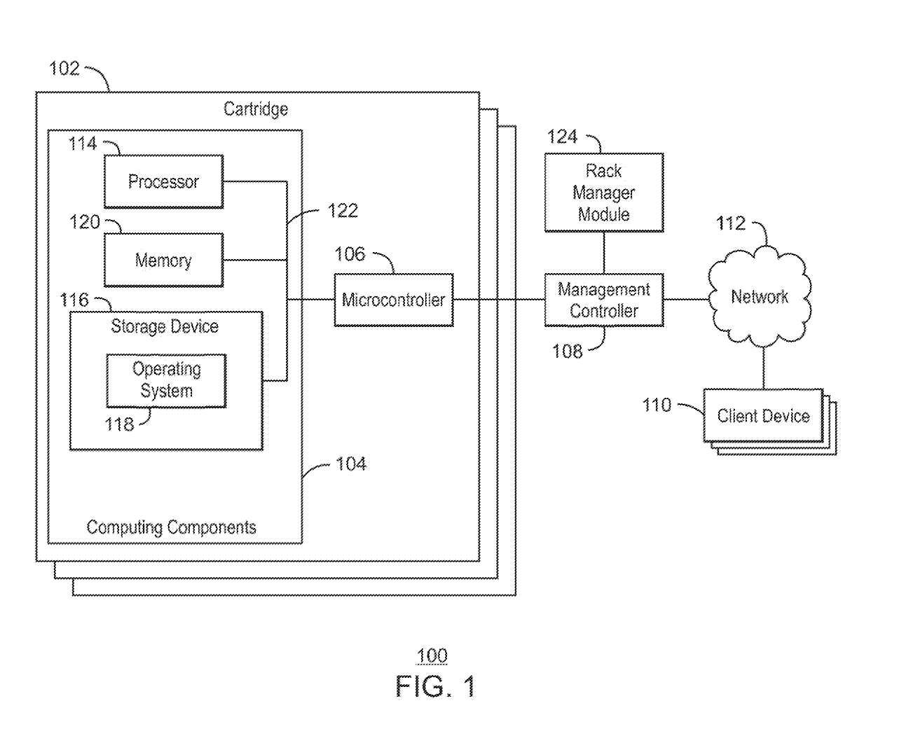

FIG. 1 is a block diagram illustrating a system including a cartridge having a microcontroller. The cartridge 102 may include computing components 104. A microcontroller 106 may monitor the computing components 104. The microcontroller 106 may receive data associated with the operation of the computing components 104, and provide the data to a management controller 108 that is remote from the cartridge 102. As illustrated in FIG. 1, the cartridge 102 may be one of many cartridges. Although not illustrated in FIG. 1, the computing components 104 may be host computing devices including servers configured to provide networked resources to client devices 110 via a network 112.

The computing components 104 may include various components such as a processor 114 and a storage device 116, comprising a non-transitory computer-readable medium. The storage device 114 may also include an operating system 118. The operating system 118 may be executed by a processor of a host computing system such as the processor 114 of the computing components 104. In some embodiments, the storage device 116 has instructions stored thereon that, when executed by the processor 114, cause the computing components 104 to perform operations. In some embodiments, the operations include responding to requests from one of the client devices 110. The processor 114 may be a main processor that is adapted to execute stored instructions. The computing components 104 may also include a memory device 120 that, in some embodiments, stores instructions that are executable by the processor 114. The processor 114 can be a single core processor, a multi-core processor, a computing cluster, or any number of other configurations. The processor 114 may be implemented as Complex Instruction Set Computer (CISC) or Reduced instruction Set Computer (RISC) processors, x86 Instruction set compatible processors, multi-core or any other microprocessor or central processing unit (CPU).

The memory device 120 can include random access memory (e.g., SRAM, DRAM, zero capacitor RAM, SONOS, eDRAM, EDO RAM, DDR RAM, RRAM, PRAM, etc.), read only memory (e.g., Mask ROM, PROM, EPROM, EEPROM, etc.), flash memory, or any other suitable memory systems. The main processor 114 may be connected through a system bus 122 (e.g., PCI, ISA, PCI-Express, HyperTransport®, NuBus, etc.) to the other computing components 104. The system bus 122 may communicatively couple the microcontroller 106 to the computing components 104.

The microcontroller 106 monitors the computing components 104 and provides data related to the computing components 104 to the management controller 108, as explained in more detail below. The controller 106 at least partially includes hardware logic. Hardware logic at least partially includes hardware, and may also include software, or firmware. Hardware logic may include electronic hardware including interconnected electronic components that perform analog or logic operations on received and locally stored information to produce an output or store resulting new information or to provide control for output actuator mechanisms. Electronic hardware may include individual chips/circuits and distributed information processing systems.

The system 100 also includes a rack manager module 124. The rack manager module 124 may include a display (not shown) having a graphical administrative interface. The rack manager module 124 may be networked with the cartridge 102 to enable a system administrator to remotely interface with the cartridge 102 via the management controller 108.

The block diagram of FIG. 1 is not intended to indicate that the computing components 104 are to include all of the components shown in FIG. 1. Further, the computing components 104 may include any number of additional components not shown in FIG. 1, depending on the details of the specific implementation.

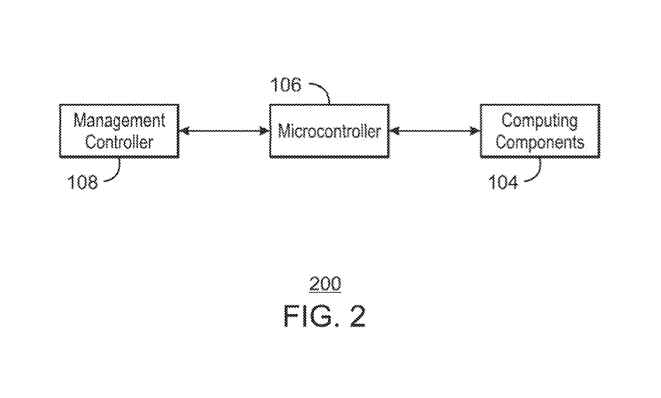

FIG. 2 is a block diagram illustrating the microcontroller in communication with the computing components and the management controller. The microcontroller 106 at least partially comprises hardware logic to receive data associated with the computing components 104 of a cartridge. The microcontroller 106 may, via the hardware logic, provide the data to the management controller 108 that is remote from the cartridge, wherein the management controller 108 is to analyze the data received and communicate operational signals to the microcontroller 106 based on the analysis.

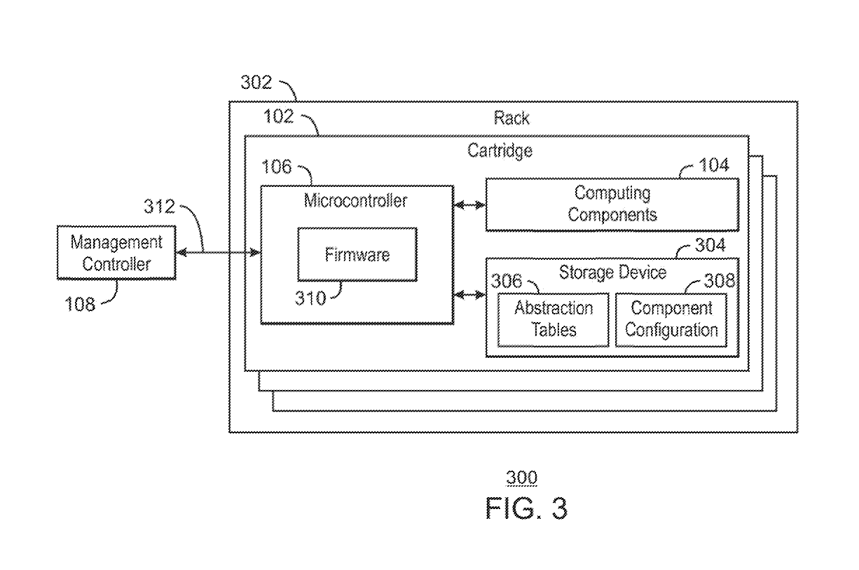

FIG. 3 is a block diagram illustrating cartridges of a rack having a microcontroller coupled to the management controller. A rack 302 may include a plurality of cartridges, such as the cartridges 102 of FIG. 1. The cartridges 102 include the microcontroller 106, the computing components 104, and a storage device 304. The storage device 304 may be remote and separate from the storage device 116 of the computing components 104 discussed above in reference to FIG. 1. The storage device 304 may be an electrically erasable programmable read-only memory (EEPROM) device.

As illustrated in FIG. 3, the storage device 304 may be communicatively coupled to the microcontroller 106. The storage device 304 includes instructions defining a configuration of the computing components 104 of the cartridge 102. For example, the instructions include abstraction tables 306 and component configurations 308. The instructions in the storage device 304 include; standard product information in intelligent platform management interface (IPMI)/field replaceable unit (FRU) format, abstraction tables (including GPI/O, I2C Buses and Devices, SPI Buses, Firmware UUIDs, Serial Console), thermal tables, IPMI sensor data records (SDRs), and the like. The microcontroller 106 includes firmware 310 configured to receive the instructions from the storage device 304. Upon the powering on the microcontroller 106, the firmware 310 is configured to read the instructions stored on the storage device 304.

In response to receiving the instructions from the storage device 304, the firmware 310 may configure the microcontroller 106 based on the instructions. For example, the microcontroller may include pins configured to communicatively monitor the computing components 104. The instructions may define the computing components 104 that are monitored by each pin or number of pins. The instructions may be provided to the management controller 108. Thus, the management controller 108 may receive data defining the configuration of the microcontroller 106 and receive data defining the configuration of the computing components 104 of the cartridge 102.

The microcontroller 106 monitors the computing components 104, As the operation of one the computing components 104 change, a state of a pin at the microcontroller 106 may change. The change may be provided in the form of a data signal to the management controller 108. The management controller 108 may, in response to the data signal, provide operational instructions to the microcontroller 106 that may then modify the operation of the computing components 104. The instructions provided by the management controller 108 may modify operations of resources that are shared by the cartridge 102 as one of a plurality of cartridges in the rack 302. For example, the rack may share cooling resources such as a fan, or power resources such as a power supply,

As another example of the operation of the microcontroller 106, one of the computing components 104 may be a power button (not shown) configured to enable power to be provided to the cartridge 102. The power button may be communicatively coupled to a pin on the microcontroller 104. When the power button is toggled to an “on” state, the pin on the microcontroller 104 may change state. This change of state may be provided by the microcontroller 106 to the management controller 108. The management controller 108 may recognize the pin as being coupled to the power button by referencing the instructions provided from the storage device 304. In response to the change of state of the pin, the management controller 108 may send instructions to the microcontroller to assert an output pin that may provide power to the computing components 104 of the cartridge 102.

Rather than analyzing the data signal at the microcontroller 106, the analysis is carried out at the management controller 108, thereby enabling the microcontroller 106 to be relatively smaller in size to a controller that may carry out the analysis at the cartridge 102. The microcontroller 106 may provide monitored data to the management controller 108 in an unanalyzed format. Further, the microcontroller 106 may be configured differently than a microcontroller at another cartridge of the plurality of cartridges shown in FIG. 2. Each of the microcontrollers may be configured differently without any change in the firmware 310 of the microcontrollers because the analysis is carried out at the management controller 108. While the configuration of the microcontroller 106 may be different at each of the cartridges, the management controller 108 enables a centralized management solution and distinct configurations at two or more of the microcontrollers.

As discussed above in reference to FIG. 1, the computing components 104 may be a host computing device such as a server. In this embodiment, the cartridge 102 is one of a plurality of cartridges of a multi-cartridge server system. However, the computing components 104 at each cartridge 102 may not necessarily be a server, but may be any combination of computing resources such as storage devices, processors, memory devices, and the like. In either embodiment, the microcontroller 104 is remote from the computing components 104 and interlaces with the management controller 108 which is remote from the cartridge. The management controller 108 may include a processor, storage, and memory, such as the processor 114, storage device 116, and memory device 120 of the computing components 104 of FIG. 1. The management controller 108 may be communicatively coupled to a plurality of microcontrollers, such as the microcontroller 106, via an interface 312. In some embodiments, the interface 312 is an Ethernet bus, wherein the data based on the monitoring of the computing components 104 is provided to the management controller 108 via Internet Protocol (IP).

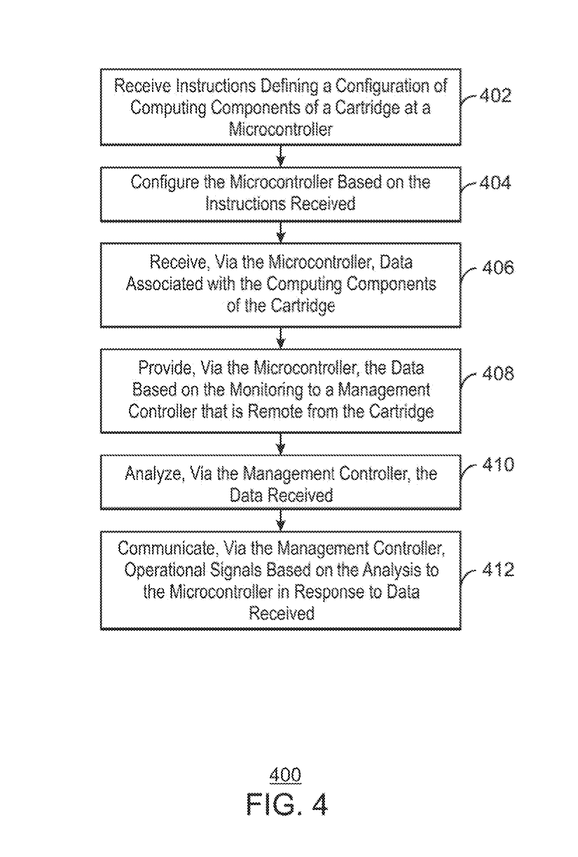

FIG. 4 is a block diagram of a method of monitoring components of a cartridge. The method 400 may include receiving, at block 402 instructions defining a configuration of computing components of the cartridge. The instructions may be stored on a storage device and may be received from the storage device at a microcontroller of the cartridge. The method 400 may include configuring, at block 404, the microcontroller based on the instructions received. The configuration instructions may be based on the type of computing components installed on the cartridge. The microcontroller may monitor operation of the computing components. The method 400 may include receiving, at block 406, data associated with the computing components of the cartridge via the microcontroller. The data may be provided, at block 408, to a management controller that is remote from the cartridge. The management controller may analyze, at block 410, the data received, and communicate, at block 412, operational signals based on the analysis to the microcontroller in response to the data received.

As discussed above in reference to FIG. 3, rather than analyzing the data at the microcontroller, the data is analyzed at the management controller which is remote from the cartridge. In some embodiments, the microcontroller may be considered a proxy for the management controller in which the data is gathered but not analyzed by the microcontroller. By providing a microcontroller that gathers data by monitoring the computing components of the cartridge, the microcontroller may be smaller in size and lower in cost than if a the microcontroller were configured to perform operations including analyzing the data of the computing components. Further, data from a plurality of cartridges may be received by the management controller from a microcontroller at each of the cartridges, respectively. The management controller may be, therefore, a centralized processor enabling the microcontrollers to have different configurations having one centralized processing mechanism.

The method 400 may also include receiving, at the management controller, data defining the configuration of the microcontroller, and data defining the configuration of the computing components. Therefore, when data is received that is associated with the operation of the computing components, the management controller may refer to the configuration data to identify the components and to identify the monitored data of the components. The management controller may provide instructions in response to data received at the microcontroller and provided to the management controller, Thus, the method 400 may include analyzing, via the management controller, the data received indicating the operations of the computing components. The method 400 may also include providing instructions to the microcontroller to modify operations of the computing components of the cartridge. In some embodiments, the method 400 may include providing instructions to modify operations of resources, such as cooling mechanisms and power supply mechanisms, that are shared by the cartridge as one of a plurality of cartridges in a rack.

The microcontroller is configured based on the configuration of the computing components of the cartridge. In some embodiments, the method 400 includes configuration of the microcontroller without any change in a firmware of the microcontroller. Because the microcontroller does not perform operations including analysis of the data received by monitoring the computing components, the microcontroller firmware may be common between all of the cartridges in a rack of a rack server system.

The terms, descriptions and figures used herein are set from by way of illustration only and are not meant as limitations. Those skilled in the art will recognize that many variations are possible within the scope of the invention, which is intended to be defined by the following claims—and there equivalents—in which all terms are meant in their broadest reasonable sense unless otherwise indicated.

What is claimed is:

1. A microcontroller, at least partially comprising hardware logic, to:
receive data associated with computing components of a cartridge; and
provide the data to a management controller that is remote from the cartridge, wherein the management controller is to analyze the data received and communicate operational signals to the microcontroller based on the analysis.

2. The microcontroller of claim 1, wherein microcontroller is disposed at the cartridge, and the management controller is to;
receive data defining the configuration of the microcontroller; and
receive data defining the configuration of the computing components of the cartridge.

3. The microcontroller of claim 1, wherein the management controller is to analyze the data received and provide instructions to the microcontroller to modify operations of:
the computing components of the cartridge;
resources that are shared by the cartridge as one of a plurality f cartridges in a rack; or
any combination thereof.

4. The microcontroller of claim 1, wherein the microcontroller is to monitor data without analyzing the data, and provides the data to the remote management controller in an unanalyzed format.

5. The microcontroller of claim 1, wherein the microcontroller is configured without any change in a firmware of the microcontroller.

6. A computing system, comprising:
a cartridge comprising a microcontroller, the microcontroller to be configured based on instructions of a storage device and to monitor data generated by components of the cartridge;
the storage device to store instructions defining a configuration of computing components of the cartridge; and
a management controller, remote from the cartridge, to:
receive the data generated by the components via the microcontroller;
analyze the data received and communicate operational signals based on the analysis to the microcontroller in response to data received.

7. The computing system of claim 6, wherein the components of computing system are managed via the operational signals provided by the management controller remote from the cartridge.

8. The computing system of claim 6, comprising pins of the microcontroller, wherein the microcontroller monitors the data generated by the computing components via changes in the pins.

9. The computing system of claim 8, wherein the computing components comprise a host computing device and the microcontroller is remote from the host computing device, and the management controller is coupled, via the microcontroller, to the host computing device.

10. The computing system of claim 6, wherein the management controller is to:
receive the instructions, via the microcontroller, defining the configuration of the computing components of the cartridge; and
receive data defining the configuration of the microcontroller.

11. The computing system of claim 6, wherein the management controller is to analyze the data received and provide instructions to the microcontroller to modify operations of:
the computing components of the cartridge;
resources that are shared by the cartridge as one of a plurality of cartridges; and
any combination thereof.

12. A method, comprising:
receiving instructions, from a storage device to a microcontroller of a cartridge, defining a configuration of computing components of the cartridge;
configuring the microcontroller based on the instructions received;
receiving, via the microcontroller, data associated with the computing components of the cartridge; and
providing, via the microcontroller, the data based on the monitoring to a management controller that is remote from the cartridge;
analyzing, via the management controller, the data received; and
communicating, via the management controller, operational signals based on the analysis to the microcontroller in response to data received.

13. The method of claim 12, wherein microcontroller is disposed at the cartridge, comprising:
receiving, via the management controller, data defining the configuration of the microcontroller; and
receiving, via the management controller, data defining the configuration of the computing components of the cartridge.

14. The method of claim 12, comprising:
analyzing, via the management controller, the data received; and
providing instructions to modify operations of:
the computing components of the cartridge;
resources that are shared by the cartridge as one of a plurality of cartridges in a rack; or
any combination thereof.

15. The method of claim 12, wherein the microcontroller is configured without any change in a firmware of the microcontroller.
